(19) United States
(12) Patent Application Publication
(10) Pub. No.: US 2024/0270890 A1
(43) Pub. Date: Aug. 15, 2024

(54) POLYALDEHYDES VIA CRYOGENIC PSEUDO-DISPERSION POLYMERIZATION

(71) Applicant: Polymer Solutions Inc, Atlanta, GA (US)

(72) Inventors: ANTHONY C. ENGLER, Atlanta, GA (US); PAUL A. KOHL, Atlanta, GA (US); JARED M. SCHWARTZ, Atlanta, GA (US)

(21) Appl. No.: 18/441,379

(22) Filed: Feb. 14, 2024

Related U.S. Application Data
(60) Provisional application No. 63/445,544, filed on Feb. 14, 2023.

(51) Int. Cl. C08G 6/00

(52) U.S. Cl. CPC C08G 6/00

(57) ABSTRACT

In a method of polymerizing aldehydes, first, at least one type of aldehyde monomer and reaction solvent are combined to form a reaction mixture. Second adding a reaction catalyst is added to the reaction mixture at reaction conditions. The mixture is cooled to a reaction temperature. The reaction solvent does not fully dissolve the reactants at the reaction conditions.

### CROSS-REFERENCE TO RELATED APPLICATION(S)

This application claims the benefit of U.S. Provisional Patent Application Ser. No. 63/445,544, filed Feb. 14, 2023, the entirety of which is hereby incorporated herein by reference.

### BACKGROUND OF THE INVENTION

### 1. Field of the Invention

The present invention relates to the polymerization of aldehydes.

### 2. Description of the Related Art

Polyaldehydes are self-immolative, which means they can be decomposed or depolymerized when triggered by an external stimulus. One such polyaldehyde, poly(phthalaldehyde) (PPA), has garnered recent interest for its functionality and stability at room temperature until a depolymerization stimulus is applied. Useful, high molecular-weight phthalaldehyde homopolymer and copolymers of phthalaldehyde with other aldehydes must be synthesized (i.e., polymerized) at cold temperatures (<−42° C.) due to their low ceiling temperature. Halogenated solvents are required due to the need to dissolve the starting monomers and catalyst for polymerization.

Self-immolative polymers are molecularly recyclable polymers which depolymerize back to their constituent monomers, or other products upon being triggered. One method of creating self-immolative polymers is to kinetically trap low ceiling temperature (Tc) polymers in a metastable state. Tc is an equilibrium temperature below which polymer can be formed from the monomer. Below Tc, the temperature will shift the equilibrium between monomer and polymer towards polymer formation. The equilibrium is shifted more toward polymer (and away from monomer) the farther the synthesis temperature is below Tc. Thus, polymer synthesis is often performed at 40° C. or more below Tc. However, the extreme low temperature (e.g., −78° C.) causes problems for the synthesis because the solvent must not freeze and the monomer, catalyst, and polymer must remain soluble in the solvent at the synthesis temperature.

Above Tc, the equilibrium shifts toward monomer and the polymer becomes thermodynamically unfavorable. When a polymer is above its Tc, the thermodynamic driving force toward depolymerization can be suppressed by inhibiting the mechanism of depolymerization. For example, if a polymer were to decompose from the ends inward, a cyclic polymer (without ends) could be stable above its Tc because it has no ends. Triggering could occur by breaking a bond in the polymer chain and creating two free ends which then could rapidly lead to the entire polymer chain depolymerizing.

Low Tc monomers must be polymerized at exceptionally low temperatures (i.e., below Tc) and be kinetically stabilized at the operating temperature (i.e., above Tc) to be useful as a self-immolative polymer. PPA is one such polymer that has been extensively studied in recent years. A typical synthesis for PPA requires the use of dichloromethane (DCM) as the solvent for polymerization. DCM has a very low freezing point (−96.7° C.) and the monomers, catalyst, and polymer are highly soluble in DCM. However, DCM is a known health and (suspected) environmental hazard. A reaction solution containing aldehyde monomers is brought to the reaction temperature (e.g., −78° C.) and polymerization is initiated by adding a catalyst. After a sufficient reaction time, the reaction mixture is quenched with a chemical compound known to either endcap a polymer chain or bind tightly to the synthesis catalyst so that the catalyst is no longer chemically active. This creates a kinetically stabilized cyclic or end-capped linear polymer chain. The reaction mixture can then be brought to room temperature, and the polymer can be isolated by precipitation from DCM by adding a second solvent where the polymer is not soluble in the second solvent. The DCM is critical to this process because DCM has a low freezing point, and the reactants and products are highly soluble in DCM. The non-polar nature of DCM contributes to its ability to act as an excellent solvent for the reactants, which are also mainly non-polar.

Purity of the resulting polymer is critical to the shelf-stability and general functionality of the PPA. If the synthesis catalyst remains active at room temperature, it can act to immediately initiate depolymerization or initiate depolymerization at a random time during storage. Traditionally, purification involves the use of multiple precipitations of the polymer to increasingly dilute the residual catalyst. While waste and time intensive, this method has been proven to be effective in creating stable PPA polymer with a long shelf-life.

A preferred solvent for producing high-purity polymer with long shelf-life is one where the monomer(s) and catalyst are readily soluble at the reaction temperature, such as DCM. However, chlorinated solvents such as DCM are costly and are an environmental hazard. Thus, there is a need to find reaction conditions and/or materials which do not require the full solubility of the reactant and products at the reaction temperature.

### SUMMARY OF THE INVENTION

The disadvantages of the prior art are overcome by the present invention which, in one aspect, is a method of polymerizing aldehydes, in which first, at least one type of aldehyde monomer and reaction solvent are combined to form a reaction mixture. Second adding a reaction catalyst is added to the reaction mixture at reaction conditions. The mixture is cooled to a reaction temperature. The reaction solvent does not fully dissolve the reactants at the reaction conditions.

In another aspect, the invention is a method of polymerizing aldehydes, in which first, at least one type of aldehyde monomer and reaction solvent are combined to form a reaction mixture. Second a reaction catalyst is added to the reaction mixture at reaction conditions. The mixture is cooled to a reaction temperature. The reaction solvent does not fully dissolve the reactants at the reaction conditions.

In another aspect, the invention is a method of polymerizing aldehydes, in which first at least one type of aldehyde monomer and a reaction solvent are combined to form a polymer product. Second, a reaction catalyst is added to the reaction mixture at reaction conditions. The reaction mixture is cooled to a reaction temperature. The reaction solvent does not fully dissolve the polymer product at the reaction conditions.

In another aspect, the invention is a method of quenching a polyaldehyde polymerization, in which first at least one type of aldehyde monomer and reaction solvent are combined to form a reaction mixture. Second, a reaction catalyst is added to the mixture. The mixture is cooled to the reaction temperature. A non-solvent that binds to the reaction catalyst to the reaction mixture is added.

In one aspect, the cooling step occurs before the reaction catalyst is added. In another aspect, the cooling step occurs before the reaction catalyst is added.

In yet another aspect, the invention is a polyaldehyde composition, that includes:
(a) a homopolymer, wherein the polymer comprises a repeating unit as shown in Formula I:

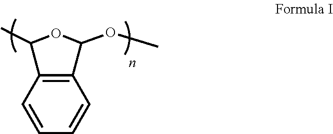

wherein n is 1 to 100,000; and
(b) a copolymer, wherein the copolymer comprises a repeating unit as shown in Formula II:

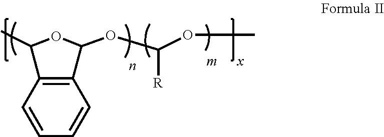

wherein
   R is a selected one of: C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and when substituted, R is substituted with a selected one of: aldehyde, amino, sulfonic acid, sulfinic acid, fluoroacid, phosphonic acid, ether, halide, hydroxy, ketone, nitro, cyano, azido, silyl, sulfonyl, sulfinyl, or thiol;
   m is 1 to 100,000;
   n is 1 to 100,000; and
   x is 1 to 100,000.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

The term “composition” is intended to encompass a product comprising the specified ingredients in the specified amounts. A mole percent (mol %) of a component is based on the number of moles of each unit of the composition in which the component is included.

The term “monomer” as used herein refers to one of the constituent compounds used to form a polymer

The term “aliphatic” as used herein refers to a non-aromatic hydrocarbon group and includes branched and unbranched alkyl, alkenyl and alkynyl groups.

The term “aldehyde” as used herein refers to a compound with at least one C(H)═O group.

The term “homopolymer” as used herein refers to a macromolecule prepared by polymerizing one monomer.

The term “copolymer” as used herein refers to a macromolecule prepared by polymerizing two or more different monomers. The copolymer can be random, block, or graft.

The term “pseudo-solvent” is a liquid which has only limited solubility for the target substances (including reactants and products) resulting is slurry-like mixture with some dissolved substances and some undissolved substances.

The preferred solvent for polyaldehyde polymerization, DCM, is costly and has associated health and environmental hazards. The reason DCM has historically been used so extensively is due to the high reactant and polymer solubility at the extreme reaction conditions. Few solvents offer the solubility at −80° C. that DCM affords. The polyaldehyde polymer synthetic methods require fully solvated reactants and products to allow the catalyst to efficiently diffuse through the reaction mixture and convert monomer and catalyst into polymer, as well as allow the quenching agent to diffuse through the reaction mixture and stabilize the polymer chains.

Surprisingly, it has been found that efficient polyaldehyde synthesis can occur in reaction solvents (e.g., an ether or an ester) with poor solubility that do not fully dissolve the monomer reactants or polymer products at the reaction conditions. These suspensions or pseudo-dispersion polymerizations can attain product polymer molecular weights and compositions comparable to the fully-solvated polymerizations.

Disclosed herein are methods for making compounds and compositions. The disclosed compounds are polymers that can degrade/decompose/dissolve upon exposure to external stimuli. One aspect of the invention relates to a composition comprising:
a) A homopolymer, wherein the polymer comprises a repeating unit as shown in Formula I:

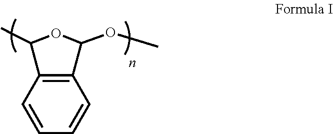

wherein n is 1 to 100,000;
b) A copolymer, wherein the copolymer comprises a repeating unit as shown in Formula II:

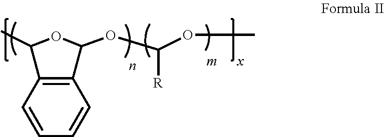

wherein R is substituted or unsubstituted C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and when substituted, R is substituted with aldehyde, amino, sulfonic acid, sulfinic acid, fluoroacid, phosphonic acid, ether, halide, hydroxy, ketone, nitro, cyano, azido, silyl, sulfonyl, sulfinyl, or thiol;
m is 1 to 100,000;
n is 1 to 100,000; and
x is 1 to 100,000.

In certain embodiments, the polyaldehyde composition is synthesized from a reaction solvent and reactants to form a polymer product wherein the reaction solvent does not fully dissolve either the reactants or the polymer product at reaction conditions.

Table 1 lists the results of homopolymerizations in DCM and in a newly found pseudo-solvent, ethyl acetate (EtOAc). The polymerizations shown in Table 1 were all carried out at −78° C. but a noticeable difference was observed in the synthesis mixture. In DCM the reactants were all soluble at the reaction temperature, −78° C. In EtOAc, the reactants and product were not fully soluble as seen by the solid suspension which formed. The polyaldehyde synthesis in ethyl acetate was also especially surprising because it has been previously reported that ethyl acetate does not dissolve polyphthalaldehyde.

TABLE 1
Molecular weights and yields for polyphthalaldehyde synthesized in
a typical fashion and in a pseudo-dispersion.

| | Mn | |
|---|---|---|
| Solvent System | (kg/mol) | Yield |
| DCM (typical) | 237.0 | 72.9% |
| EtOAc | 151.8 | 68.4% |

Polymerization typically occurs with a catalyst added once the reaction solution is at the optimum reaction temperature. The temperature at which catalyst is added is critical to avoid the formation of undesirable byproducts as the reaction mixture is cooled. In DCM, the catalyst is added at low temperature which causes manufacturing problems because it is difficult to pre-cool the catalyst before addition to the reaction vessel. In ethyl acetate solvent, it has been surprisingly found that the catalyst can be added at room temperature or at an elevated temperature from the eventual polymerization conditions. In ethyl acetate, it has been found that adding the catalyst at low temperature (i.e., below the temperature of formation for the unwanted byproducts) yields polymer with similar composition and stability to polymer with catalyst added at colder temperatures. That is, the restriction of catalyst addition only at low temperature with DCM is removed when using ethyl acetate as the synthesis solvent. Table 2 shows data for three ethanal-phthalaldehyde copolymers using a typical solvent, DCM, and solvents with low reactant solubility, EtOAc and ethanal. The reaction with ethanal as a solvent must be initiated while ‘warmer’ than the ideal reaction temperature (−78° C.) to ensure some yield because undesirable byproducts form above −40° C.

TABLE 2
Comonomer content, molecular weight, and yield for
phthalaldehyde-ethanal copolymers. Note catalyst was added
at a warmer temperature for the ethanal solvent system.

| | | Mn | |
|---|---|---|---|
| Solvent System | Ethanal Content | (kg/mol) | Yield |
| DCM | 26 mol % | 64.0 | 37.6% |
| EtOAc | 26 mol % | 10.4 | 40.8% |
| Ethanal | 25 mol % | 3.8 | 5.2% |

It is noted that the above-described polymerization can be carried out in a batch reactor where ingredients are combined in a single vessel. Alternatively, the polymerization can be carried out in a continuous-flow reactor where the ingredients are continuously fed in a tube-like configuration. Mixing and reaction occur in the tube of the continuous-flow reactor.

The polyaldehyde product is recovered from the synthesis solvent by precipitation. A typical precipitation involves the dropwise addition of the reaction solution into a liquid which the polymer is not soluble in (also known as a non-solvent), such as methanol. The polymer precipitates out of solution, providing a powder-like product. Unfortunately, this method is time intensive and solvent wasteful. Another method of purifying the polymer by deactivating the catalyst involves the use of a solvent for the polymer, such as tetrahydrofuran (THF). THF is known to bind more preferentially to the catalyst more strongly than the catalyst binds to the polymer. In this way, the catalyst is deactivated and cannot depolymerize the polymer when the polymer is heated to a temperature above Tc. The THF-catalyst adduct can then be removed through a precipitation into a non-solvent such as methanol or hexane.

Certain poor-solvents (i.e., limited solubility) for the polymer have been shown to effectively bind to the catalyst and prevent accidental depolymerization of the polyaldehyde product. This is one method of quenching the reaction, which involves pyridine or a similar, strong Lewis base.

The two methods can be combined where a poor-solvent, such as pyridine, and a solvent for the polymer, such as THF, can bind to the catalyst and quench further reactions. The THF can not only participate in the quenching of the catalyst, but it will also aid in the dissolution of the pyridine-catalyst adduct that formed. The resulting solution can be precipitated into a poor-solvent, such as MeOH, and the polymer recovered.

Surprisingly, adding a poor-solvent, such as MeOH, is enough to quench the reaction, remove sufficient catalyst, and ensure long term stability of the polyaldehyde product. Table 3 shows the various methods discussed above for the quenching of a polymerization of phthalaldehyde with their molecular weight and yield.

TABLE 3
Polymerization results for multiple quenching methods.

| Solvent | | Mn | |
|---|---|---|---|
| System | Quench Method | (kg/mol) | Yield |
| DCM (typical) | Pyridine/Precipitation (typical) | 237.0 | 72.9% |
| EtOAc | Pyridine/Precipitation | 17.9 | 32.0% |
| EtOAc | THF/Pyridine | 151.8 | 68.4% |
| EtOAc | MeOH/Pyridine | 157.7 | 76.4% |

Polymerizations of phthalaldehyde are typically done in a batch manner, where all reactants are added to a single vessel that retains the reactants and products until precipitation or filtration. A method has been demonstrated where polymer could be removed as it forms and precipitated out of solution continuously, thereby creating a continuous reactor.

In addition, this method of pseudo-dispersion could be beneficial in a system with a solvent that is gaseous at ambient temperature and pressure. A reaction mixture could be pressurized and/or cooled until the gas is liquid, thereby dissolving portions of the reactants and proceeding with the polymerization reactions, as described above. This type of polymerization would require the use of variable pressures and temperatures to achieve the proper ratio of dissolution.

In certain embodiments, suitable reaction solvents include diethyl ether, cyclopentyl methyl ether, tetrahydrofuran, ethyl acetate, methyl formate, and monoglyme. In such embodiments the solvent can be a polar aprotic solvent including a solvent that is an aldehyde for incorporation into a polymer as a comonomer.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described herein, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of polymerizing aldehydes, comprising the steps of:
(a) first combining at least one type of aldehyde monomer and reaction solvent to form a reaction mixture;
(b) second adding a reaction catalyst to the reaction mixture; and
(c) cooling the mixture to a reaction temperature,
wherein the reaction solvent does not fully dissolve the reactants at reaction conditions.

2. The method of claim 1, wherein the reaction solvent is a non-polar solvent including a selected one of an ether or an ester.

3. The method of claim 2, wherein the selected one of an ether or an ester is selected from a list consisting of: diethyl ether, cyclopentyl methyl ether, tetrahydrofuran, ethyl acetate, methyl formate, and monoglyme.

4. The method of claim 1, wherein the solvent is a polar aprotic solvent including a solvent which is an aldehyde for incorporation into a polymer as a comonomer.

5. The method of claim 1, wherein the cooling step occurs before step of adding a reaction catalyst.

6. The method of claim 1, wherein the cooling step occurs after step of adding a reaction catalyst.

7. A method of polymerizing aldehydes, comprising the steps of:
(a) first combining at least one type of aldehyde monomer and a reaction solvent to form a polymer product;
(b) second, adding a reaction catalyst to the reaction mixture at reaction conditions; and
(c) cooling the reaction mixture to a reaction temperature,
wherein the reaction solvent does not fully dissolve the polymer product at the reaction conditions.

8. The method of claim 7, wherein the reaction solvent is a non-polar solvent including a selected one of an ether or an ester.

9. The method of claim 8, wherein the elected one of an ether or an ester is selected from a list consisting of: diethyl ether, cyclopentyl methyl ether, tetrahydrofuran, ethyl acetate, methyl formate, and monoglyme.

10. The method of claim 7, wherein the solvent is a polar aprotic solvent including a solvent which is an aldehyde intended to be incorporated into the polymer as a comonomer.

11. The method of claim 7, wherein the cooling step occurs before step of adding a reaction catalyst.

12. The method of claim 7, wherein the cooling step occurs after step of adding a reaction catalyst.

13. A method of quenching a polyaldehyde polymerization, comprising the steps of:
(a) first combining at least one type of aldehyde monomer and reaction solvent to form a reaction mixture;
(b) second, adding a reaction catalyst to the mixture;
(c) cooling the mixture to the reaction temperature, and
(d) adding a non-solvent that binds to the reaction catalyst to the reaction mixture.

14. The method of claim 13, wherein the cooling step occurs before step of adding a reaction catalyst.

15. The method of claim 13, wherein the cooling step occurs after step of adding a reaction catalyst.

16. A polyaldehyde composition, comprising:
(a) a homopolymer, wherein the polymer comprises a repeating unit as shown in Formula I: 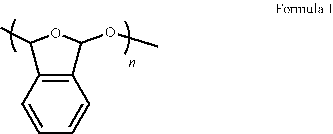
wherein n is 1 to 100,000; and
(b) a copolymer, wherein the copolymer comprises a repeating unit as shown in Formula II: 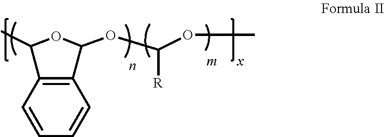
wherein
R is a selected one of: C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and when substituted, R is substituted with a selected one of: aldehyde, amino, sulfonic acid, sulfinic acid, fluoroacid, phosphonic acid, ether, halide, hydroxy, ketone, nitro, cyano, azido, silyl, sulfonyl, sulfinyl, or thiol;
m is 1 to 100,000;
n is 1 to 100,000; and
x is 1 to 100,000.

17. The polyaldehyde composition of claim 16, wherein the polyaldehyde composition is synthesized from a reaction solvent and reactants to form a polymer product wherein the reaction solvent does not fully dissolve either the reactants or the polymer product at reaction conditions.
